(19) United States
(12) Patent Application Publication
(10) Pub. No.: US 2008/0304135 A1
(43) Pub. Date: Dec. 11, 2008

(54) In-Plane Switching Electrophoretic Display

(75) Inventors: Martinus H.W.M. Van Delden, Eindhoven (NL); Roland M. Schuurbiers, Best (NL); Mark T. Johnson, Velhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/158,343

(22) PCT Filed: Dec. 14, 2006
(86) PCT No.: PCT/IB2006/054853

§ 371 Date: Jun. 20, 2008

Related U.S. Application Data
(60) Provisional application No. 60/752,091, filed on Dec. 20, 2005.

(30) Foreign Application Priority Data
Jun. 2, 2006 (EP) 06114953.0

(51) Int. Cl. G02B 26/00; H01J 9/24

(52) U.S. Cl. 359/296; 445/24

(57) ABSTRACT

A pixel having an upper substrate and a base carrier disposed opposite each other; a dielectric fluid with dispersed electrophoretic particles filled in a gap between the upper substrate and the base carrier; a wall disposed on at least one of the upper substrate and the base carrier between adjacent pixels, preventing migration of the electrophoretic particles between the adjacent pixels; a surrounding electrode disposed in proximity to the wall and extending substantially parallel to an interior surface of the wall; and a facilitating structure positioned along an inner surface of the surrounding electrode, and having a curved inner surface, wherein the facilitating structure is electrically floating relative to the surrounding electrode. The pixels may be used with particles that are colored, black white, and/or reflective. The pixels may incorporate color filters therein.

The present system relates to electrophoretic displays and particularly relates to in-plane electrophoretic displays that have improved switching characteristics.

Electrophoretic display devices are displays of the reflective type or transmissive type that utilize charged particles in a dielectric fluid (liquid or gas) positioned in pixels to provide visually recognizable images to the viewer. An example of an electrophoretic display device is provided in U.S. Pat. No. 8,612,758 (the '758 Patent) to Lee et al. incorporated herein in entirety by reference thereto. The device in the '758 patent consists of substrates disposed opposite each other, with a gap therein, a colored dielectric liquid in the gap, charge particles dispersed in the liquid, and electrodes disposed along the substrates. Through applying electric fields of different polarity to this device, the particles may be made to migrate from one electrode to the other. This type of electrophoretic display device is referred to as a “vertical migration type”.

Several problems have arisen in vertical migration type electrophoretic displays, including deterioration of the service life, stability of the display device, and lowered display contrast. In-plane switching (“IPS”) electrophoretic display devices, termed horizontal migration display devices, utilize electrodes positioned on a bottom substrate, and on the wall of the pixel, termed the collecting electrode. Such design has addressed some problems with the vertical migration type electrophoretic displays, however issues remain, such as having a switching speed that is asymmetric and slow, and often, the electrophoretic displays require a high drive voltage. Attempts to address these issues have resulted in the production of “thick” pixels (i.e. pixels with relatively high walls arising from matching the surface area of the collecting electrode to the display electrode) which the height causes decreased viewing angles, aperture loss, and reduced brightness and contrast in the display device.

In electrophoretic displays, the charged particles are generally subject to a force which appears between the display electrodes, which act along a direction of an electric field vector and are proportional to the magnitude of the electric field vector. It is thus desirable that at each controlled pixel, an electric field of similar strength be exerted on all electrophoretic particles. However, in horizontal migration type electrophoretic display devices, the magnitude of the electric field vector generated is strong in the peripheral regions of the display electrodes and weak in the central regions of the display electrodes. As a result, a non-uniform electric field is exerted on the electrophoretic particles the pixels or sub-pixels of the display device. The non-uniform electric field results in non-uniform coverage of the pixels by the electrophoretic particles that produce an uneven or gapped pixel image wherein, for example, a center and other portions of the pixel have uneven distribution. Increasing the charge to the electrodes solves some of the electrophoretic particle distribution problems however, typically creates others such as uneven electrophoretic particle distribution around the edges of the pixel.

It is an object of the present system to overcome these and other disadvantages in the prior art.

The present system proposes a pixel useful in an electrophoretic display device that allows for more uniform distribution of charged particles contained therein. Through the present system, pixels may be developed that improve the switching speed of the particles, reduce image retention, require only low drive voltage, provide good viewing angle by avoiding the use of “thick” pixels, improves the grayscale gradation in black and white systems, and improves the switching speed in colored display devices.

The present display system includes a pixel having an upper substrate and a base carrier disposed opposite each other; a dielectric fluid (i.e. a liquid or a gas) with dispersed electrophoretic particles filled in a gap between the upper substrate; a wall disposed on at least one of the upper substrate and the base carrier between adjacent pixels, to prevent migration of the electrophoretic particles between the adjacent pixels; a surrounding electrode disposed in proximity to the wall and extending substantially parallel to an interior surface of the wall; and a facilitating structure, which may be a conductor or an insulator.

When the facilitating structure is a conductor, the facilitating structure may advantageously be positioned substantially along an inner surface of the surrounding electrode and having a curved inner surface that is electrically floating relative to the surrounding electrode. The facilitating structure may be continuous or discontinuous along the inner surface of the surrounding electrode. In one embodiment, an exterior surface of the facilitating structure is substantially parallel to the inner surface of the surrounding electrode.

An exterior surface of the wall may be structured as a closed geometric shape having at least three sides.

The pixel may include a drive electrode, disposed in proximity to the base carrier and extending substantially parallel to an interior surface of the base carrier. The facilitating structure may be centered substantially over the drive electrode.

When the facilitating structure is made of one or more insulating materials, the facilitating structure may advantageously be positioned substantially over a drive electrode or underneath a drive electrode or both over and underneath a drive electrode and may consist of one or more stacked materials. The facilitating structure may be formed from one of a transparent, semi-transparent, and colored material. In an embodiment of the present device, the facilitating structure is a first facilitating structure and one or more windows may be structured in a center portion of the drive electrode and a second facilitating structure may be positioned below the drive electrode.

A planarizing layer may be positioned above the drive electrode, to exclude the dielectric fluid (i.e. a liquid or a gas) from between the planarizing layer and the drive electrode and to produce an increasing gap between the drive electrode and the dielectric fluid. The planarizing layer may be structured to form one of a slope, a pyramid, a cavern, and a cutout surface facing the dielectric fluid. The drive electrode and the base carrier may be structured such that the planarizing layer produces a surface area in contact with the dielectric fluid (i.e. a liquid or a gas) that is substantially flat. In one embodiment, the planarizing layer is a first planarizing layer and the pixel may include a second planarizing layer deposited onto the first planarizing layer to produce a surface area in contact with the dielectric fluid that is substantially flat. The second planarizing layer may be an anti-sticking layer.

In an embodiment with both a first planarizing layer and a second planarizing layer, the second planarizing layer may be deposited onto the base carrier in between the drive electrode and the base carrier to produce a surface area of the first planarizing layer in contact with the dielectric fluid (i.e. a liquid or a gas) that is substantially flat. In one embodiment, the planarizing layer may be formed from a transparent material, and the pixel may include a colored filter positioned below the planarizing layer. The colored filter may be formed as one of a plurality of colored filters colored in one of an RGB color system, a CMY color system, and a combination of RGB and CMY color system.

It should be expressly understood that the drawings are included for illustrative purposes and do not represent the scope of the present system. In the accompanying drawings, like reference numbers in different drawings may designate similar elements.

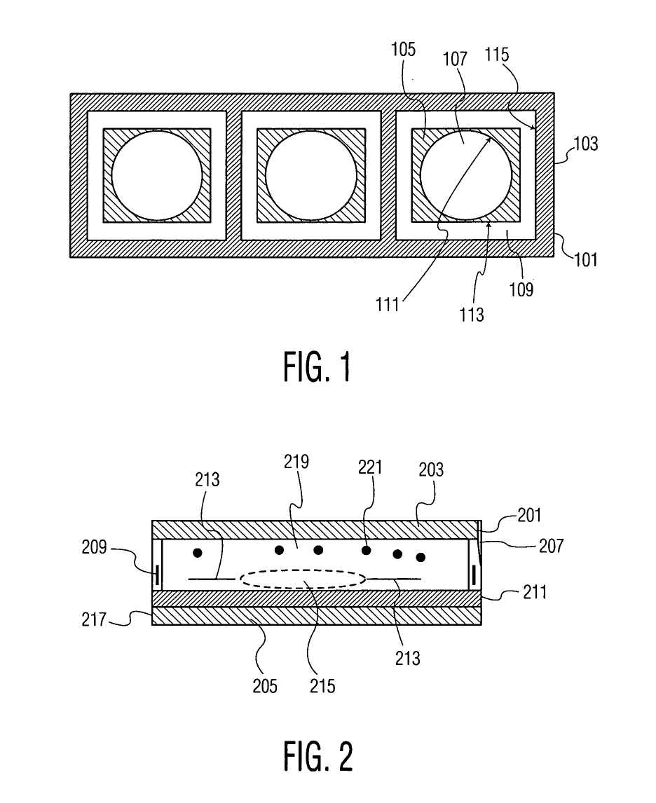

FIG. 1 illustrates a top-view of a pixel display system in accordance with an embodiment of the present system;

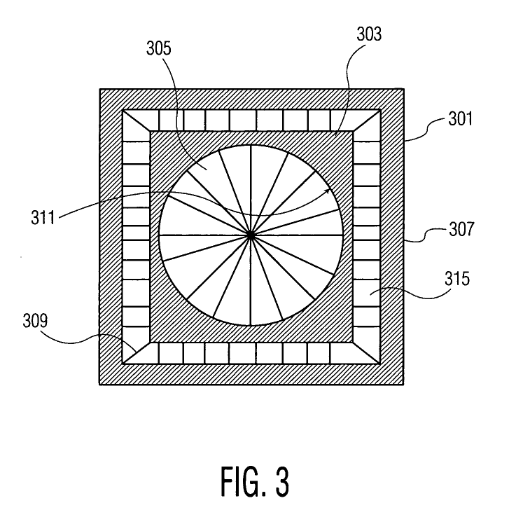

FIG. 2 illustrates a cross-sectional view of a pixel display system in accordance with an embodiment of the present system;

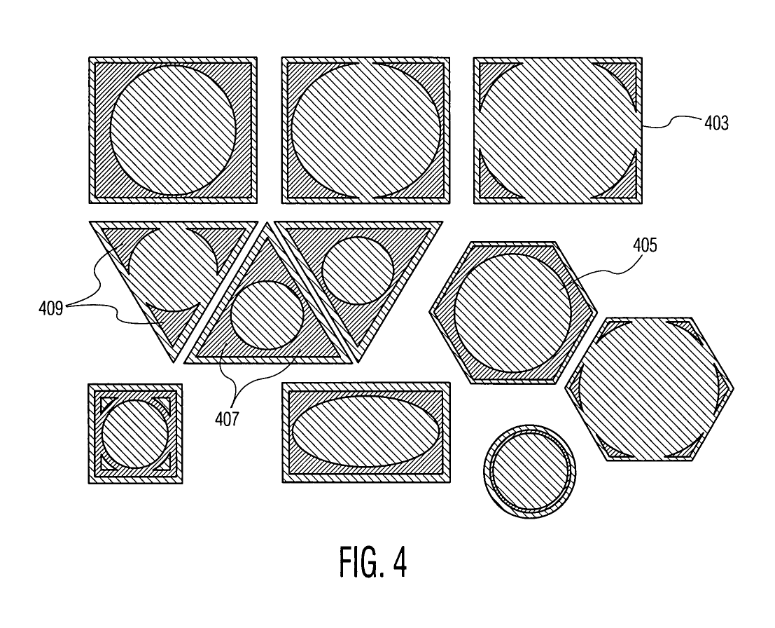

FIG. 3 illustrates a distribution of electric field lines in accordance with an embodiment of the present system;

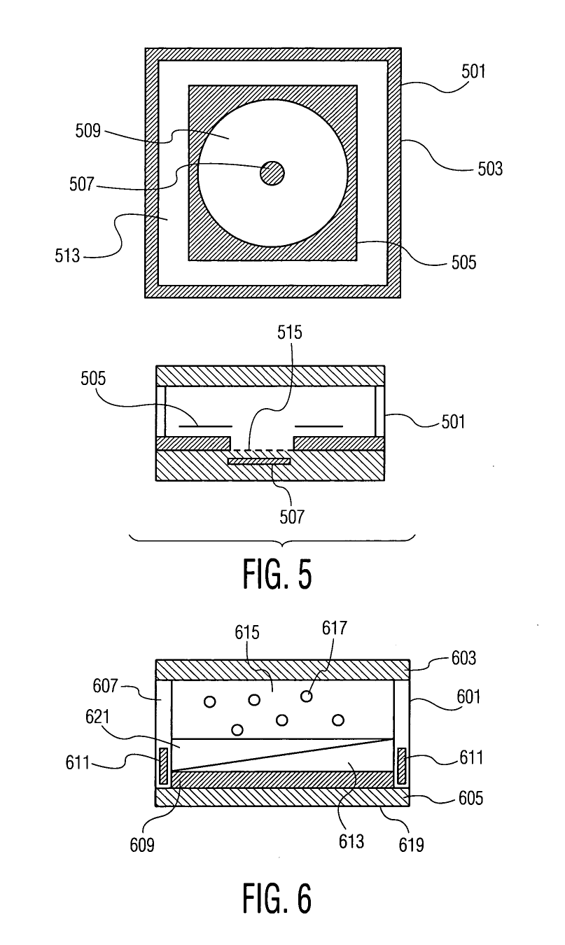

FIG. 4 illustrates different shape pixels that may be utilized to increase pixel density in accordance with an embodiment of the present system;

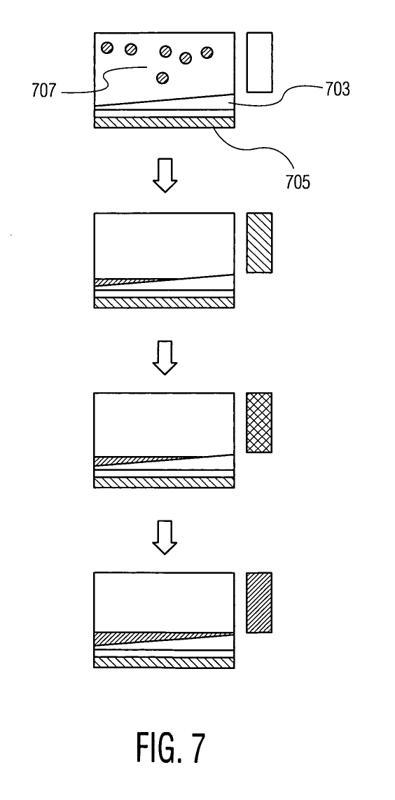

FIG. 5 illustrates an embodiment of the present system;

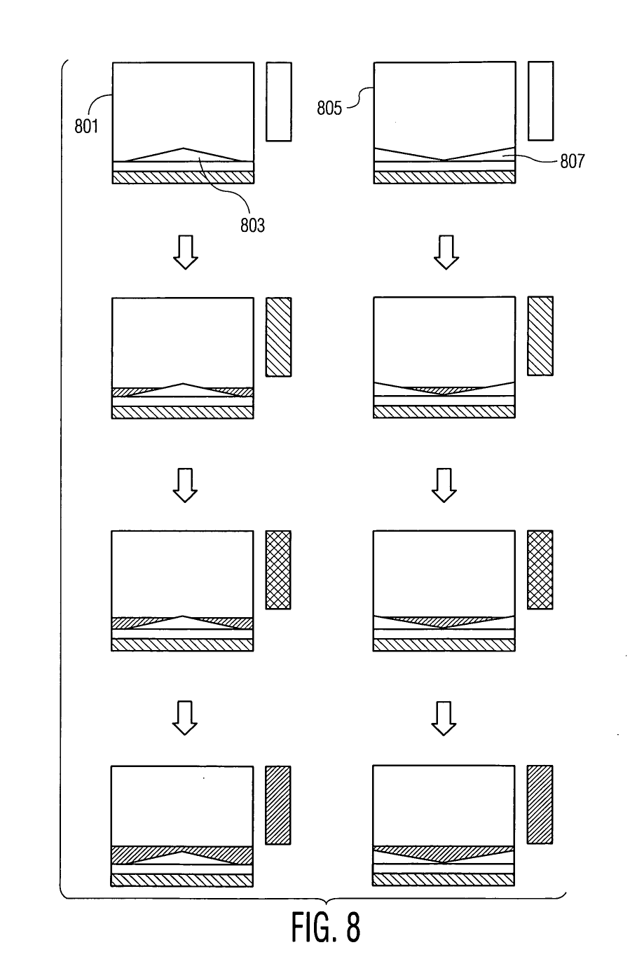

FIG. 6 illustrates another embodiment of the present system;

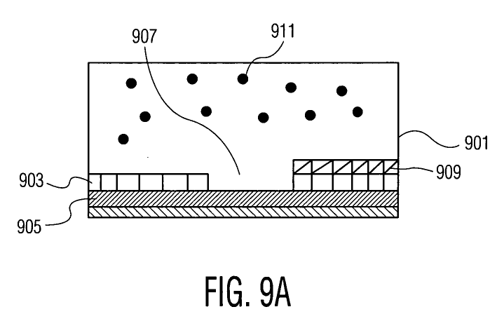

FIG. 7 illustrates operation of an embodiment of the present system;

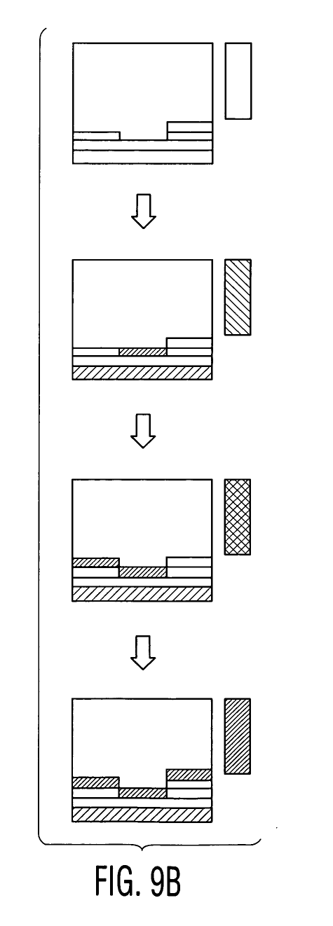

FIG. 8 illustrates further operation of embodiments of the present system;

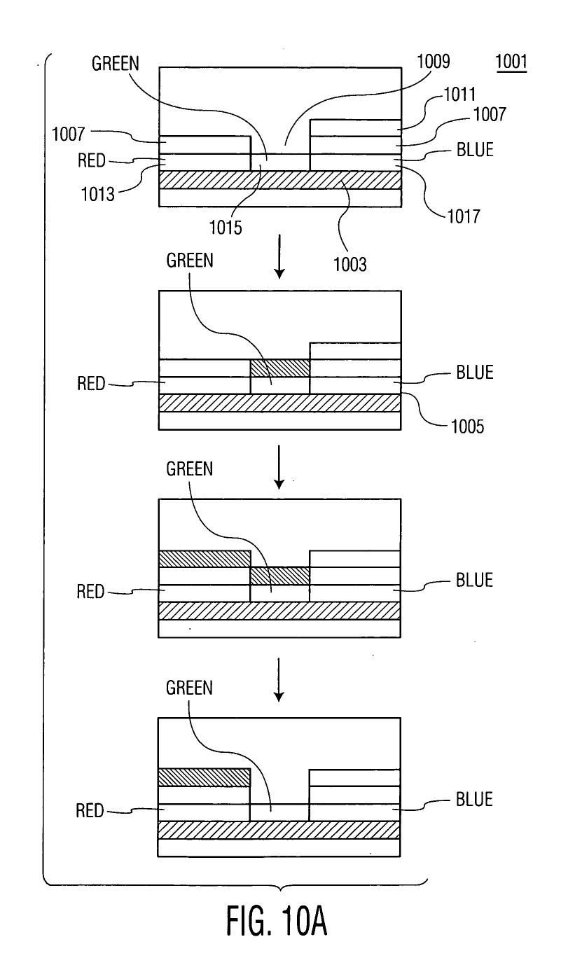

FIGS. 9A, 9B illustrate another embodiment of the present system; and

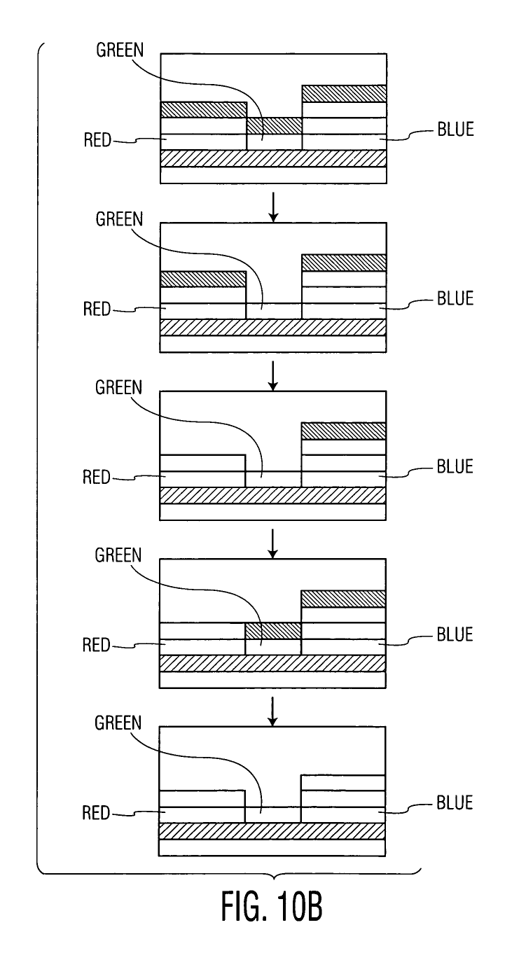

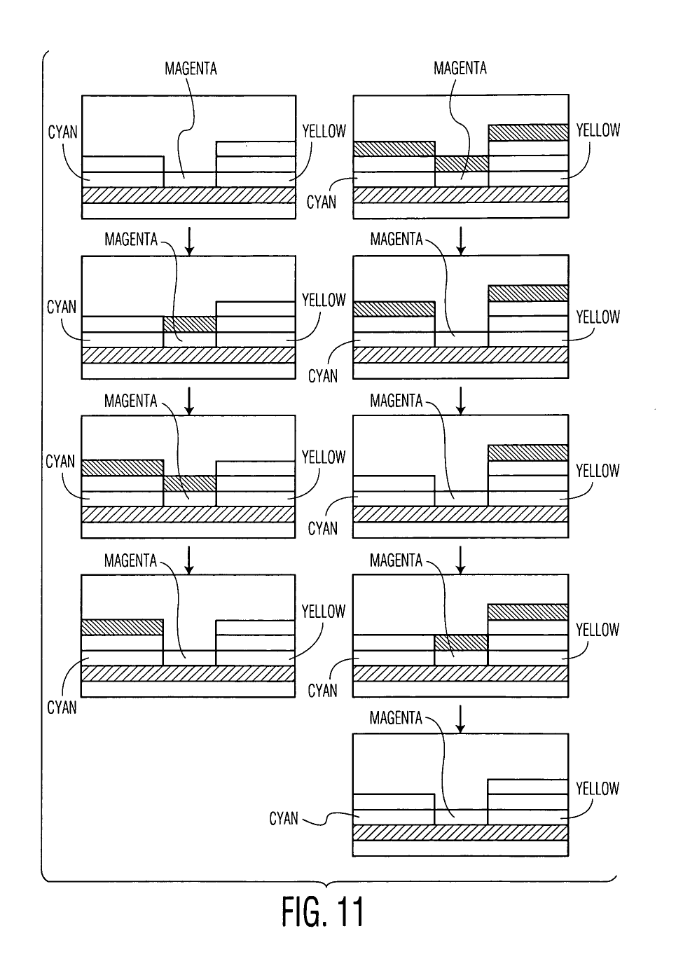

FIGS. 10A, 10B and 11 illustrate operation of an embodiment of the present system.

As a person of ordinary skill in the art will realize, the term “display device” as used herein throughout refers to any device that utilizes movable particles to display images to be visualized by viewers, including but not limited to IPS electrophoretic displays having a common electrode surrounding every pixel, such electrode operating as a guard electrode and a collecting electrode, and IPS electrophoretic displays with a guard electrode made in the form of a thin film structure in the plane of the display. The term also refers to electrophoretic displays not having a common electrode. The display devices may conform, but are not required to conform, to standard IPS AMLCD infrastructure.

The term “pixel” as utilized herein refers to specified cell-like structures contained within the display device. The cell-like structures are not limited to size, shape, or design, and therefore may be encompassing of a variety of shapes and configurations useful for producing the display devices of the instant invention including sub-pixels.

The term “electric field line” refers to a force acting along a direction of an electric field vector, such force originating from a starting electrode and proceeding in a direction toward a destination electrode.

The terms utilized herein regarding orientation and position are utilized with reference to a picture element (pixel). Accordingly, terms such as interior, exterior, etc. are with reference to the pixel structure including outside wall that define the pixel limit. Accordingly, terms such as interior, exterior, etc., refer to the portions of the pixel that are within the (outside) wall of the pixel with the exception of the term “exterior surface of the wall of the pixel,” and the like, which is self explanatory. Other orientation references are all intended to refer to the space within the outside wall of the pixel. In this light, a person of ordinary skill in the art will readily appreciate the further orientation references herein.

FIGS. 1-5 illustrate an embodiment of the present pixel display system wherein a facilitating structure is utilized in a pixel to redistribute electric field lines that are initiated by applying a voltage differential between one or more drive electrodes and one or more further (“common”) electrodes.

FIG. 1 shows a top view of several pixels 101 that may be utilized in a display device including an exterior wall 103, a conducting and electrically floating facilitating structure 105, an inner formation 107 created by an interior surface 111 (with regard to an interior portion of a pixel) of the facilitating structure 105, and a drive electrode 109. Optionally, the inner formation 107 may be curved, circular, oval, elongated oval, or other regular and/or irregular continuous or discontinuous curved structures. The following examples will be illustrated with preferred, curved formations.

Illustratively, the wall 103 as shown in FIG. 1, for each pixel 101, may be square-shaped. However, as shown in FIG. 4, the wall may be shaped in any format, including but not limited to, rectangular, triangular, hexagonal, octagonal, and other closed geometric shapes, for example in two-dimensions, having at least three sides, and curved shapes including circular and oval shaped or otherwise, to facilitate pixel density. An interior surface 115 of the wall 101 defines an interior space (e.g., an enclosed pixel cavity) of the pixel. In this way, the interior surface 111 of the facilitating structure 105 defines an inner formation 107 for the pixel 101.

In forming the inner formation 107 for the pixel 101, the interior surface of the facilitating structure 105 may be, for example, but not limited to, spherical, oval shaped, elongated oval, or other continuous or discontinuous, regular or irregular, curved structures. An exterior surface 113 of the facilitating structure 105 may be a variety of shapes including but not limited to, rectangular, triangular, hexagonal, octagonal, and other closed geometric shapes, for example in two-dimensions, having at least three sides, and curved shapes including circular and oval shaped, or a cutout formation (e.g., non-continuous) thereof. The exterior surface 113 of the facilitating structure 105 may be, but is not required to be, shaped to substantially conform to (e.g., match) the shape of the interior surface 115 of the wall 103.

The facilitating structure 105 may be structured from a transparent, semi-transparent, colored, or not, material and may be made of a variety of materials suitable for conducting electricity, for example, indium-tin-oxide (ITO), titanium nitride (TiN), aluminum (Al), titanium (Ti), conducting polymer films such as, for example, carbon or metal particle filled poly (ethylene terephthlate) (PET) or polyether sulfone (PES) other materials of the like as may be suitably utilized. The structure 105, illustratively made by conventional methods, may be one continuous piece, or may be discontinuous with the interior surface 111 forming a generally curved inner formation.

The drive electrode 109 is illustratively extended for the length and width of the pixel 101, although the drive electrode 109 may be discontinuous, such as may be utilized for structuring sub-pixels as would be appreciated by a person of ordinary skill in the art. Materials used for the electrode 109 may include metals, such as titanium (Ti), aluminum (Al), gold (Au), copper (Cu), chromium (Cr), molybdenum (Mo), ITO or the like, carbon, silver paste, a conductive high polymer material, and other materials of the like. In a case wherein the drive electrode 109 is used as a light reflection layer (e.g., for a reflective electrophoretic cell), a material having a high reflectivity such as silver (Ag), aluminum (Al) or the like may also be suitably utilized.

The facilitating structure 105 in relation to the drive electrode 109 may be centered directly over the drive electrode 109 and positioned a distance from the wall 103 such that the facilitating structure 105 functions as a floating electrode (e.g., not in direct electrical contact with the drive electrode 109). The facilitating structure 105 may be formed to provide curved inner formations 107 of different diameters. The exterior wall 113 of the facilitating structure 105 may be positioned (e.g., formed or later processed) next to the interior surface 115 of the pixel wall 103, or may be positioned slightly therefrom. The width and length of the facilitating structure 105 may vary depending on the desire of the manufacturer of the display device considering affects to characteristics of the pixel including aperture loss, reduction in pixel brightness, viewing angle, guarding potential, driving voltage, image retention, and other characteristics of the pixel as would be readily appreciated by a person of ordinary skill in the art. The width and length of the facilitating structure 105 may or may not be equal to each other.

The inner formation 107 formed by the interior surface 111 of the facilitating structure 105 may have a radius equidistant from the side of the facilitating structure 105, or may exhibit a generally curved shape wherein one or more sides of the curved inner formation 107 may have a radius larger or smaller than other side(s) of the curved inner formation 107.

FIG. 2 is a cross-sectional view of an electrophoretic display including a pixel 201, including a top substrate 203, a base carrier 205, pixel wall 207, common (surrounding) electrode 209, a drive electrode 211, a facilitating structure 213, an inner curved formation 215, a voltage driving device 217, a dielectric fluid 219, and charged particles 221 dispersed (e.g., suspended) within the fluid (e.g. liquid or gas) 219. The top substrate 203 and the base carrier 205 are disposed opposite each other. The dielectric liquid 219 is filled in a gap between the top substrate 203 and the base carrier 205. The wall 207 is disposed on at least one of the top substrate 203 and the base carrier 205 between adjacent pixels (see, FIG. 1), to prevent migration of the electrophoretic particles 221 between the adjacent pixels. The common electrode 209 is disposed in proximity to the wall and extends substantially parallel to an interior surface of the wall. The common electrode may be provided in the form of a thin conductive structured film on the surface of the base carrier or there may be an additional common electrode in the form of a thin conductive structured film on the surface of the base carrier 205. The facilitating structure 213 is positioned along an inner surface of the surrounding electrode 209, and is structured having a curved inner surface and to be electrically floating relative to the surrounding electrode 209.

The top substrate 203 may be made of a transparent material, such as polymer films including but not limited to poly(ethylene terephthlate) (PET), polyether sulfone (PES), and inorganic materials such as glass, quartz, and other materials of the like as may be suitably utilized. Typically, electrically conductive materials are not used to make the top substrate 203.

The base carrier 205 may be a large area electronics device such as an active matrix. In a preferred series of embodiments, the active matrix device is realized using thin film transistor (TFT) technology to ensure that all pixels can be independently driven. TFTs are well known switching elements in thin film, large area electronics, and have found extensive use in e.g. flat panel display applications. Industrially, the major manufacturing methods for TFTs are based upon either amorphous-Si (a-Si) or low temperature polycrystalline Si (LTPS) technologies, although other technologies such as organic semiconductors or other non-Si based semiconductor technologies (such as CdSe or ZnO) can be used.

While offering somewhat less flexibility than using TFTs, it is also possible to realize an active matrix based device according to this invention using the technologically less demanding thin film diode technology or metal-insulator-metal (MIM) diode technology.

The base carrier 205 may be formed from an electrically conductive material, including but not limited to, polymer films such as poly(ethylene terephthlate)(PET), polyether sulfone (PES), and inorganic materials such as quartz and other materials of the like as may be suitably utilized. The base carrier 205 is operably coupled to the voltage applying device 217. The base carrier 205 may be formed to accommodate the drive electrode 211. The drive electrode 211 may be formed to span the length and width of the pixel 201 or some portion thereof. As stated above with regard to FIG. 1, the drive electrode 211 may be made of metals, such as titanium (Ti), aluminum (Al), gold (Au), copper (Cu) or the like, carbon, silver paste, or a conductive high polymer material.

The pixel wall 207 is positioned between the top substrate 203 and bottom base carrier 205. The pixel wall 207 forms the interior portion of the pixel 201. The pixel wall 207 may be made formed from a polymer resin or other suitable material. The pixel wall 207 may be formed having the common electrode 209 embedded or partially embedded therein or, additionally or alternatively, a common electrode may be formed as a thin conductive structured film situated on the surface of the base carrier 205. The common electrode 209 may be formed having a height equal to, or less than, a height of the pixel wall 207. The enclosing electrode 209 may be made of a conducting material, such as titanium (Ti), aluminum (Al), gold (Au), copper (Cu), or the like, carbon, silver paste, a conductive high polymer material, etc.

The facilitating structure 213 is positioned above the drive electrode 211 illustratively in a generally parallel manner. A dielectric material is positioned between the facilitating structure 213 and the drive and common electrodes 211, 209. In this manner, the facilitating structure 213 is floating with respect to the drive electrode 211 and the common electrode 209. In other words, the facilitating structure 213 is not electrically coupled to (e.g., insulated from) the drive electrode 211 and the common electrode 209. The positioning of the facilitating structure 213 within an electric field that is induced between the drive and common electrodes 211, 209, results in a redistribution of electric field lines and thereby, better particle distribution over a viewing area of the pixel as discussed in more detail below.

A distance of the facilitating structure 213 from the wall 207 may be adjusted in relation to the distance of the facilitating structure 213 from the drive electrode 211, including in some embodiments taking into account the pixel size (e.g., a read diameter), such that, particle displacement, including towards a center of the pixel, is increased even in the case of a circular shaped pixel.

An anti-sticking layer may be positioned between the drive electrode 211 and the facilitating structure 213. As discussed above regarding FIG. 1, an interior surface of the facilitating structure 213 forms an inner curved formation 215 above the drive electrode 211. The facilitating structure 213 illustratively may be formed substantially centered within the pixel 201 such that it is generally equidistant from the pixel wall 207, although variations in this positioning may be suitably utilized. An exterior surface of the facilitating structure 213 may be formed in any shaping structure, including, but not limited to, rectangular, triangular, hexagonal, and other closed geometric shapes, for example in two-dimensions, having at least three sides, and curved shapes including circular and oval shaped, and so forth. In accordance with an embodiment of the present system, the exterior surface of the facilitating structure 213 may generally follow the contours of an interior surface of the pixel wall 207, although other variations may be suitably introduced as would be readily appreciated by a person of ordinary skill in the art. The interior surface of the facilitating structure 213 may be a generally curved shape forming a generally curved interior space within the pixel 201.

The dielectric fluid 219 (i.e. a liquid or a gas) may be colored or colorless, generally transparent and made of, for example, silicone oil, toluene, xylene, high purity petroleum, or other generally transparent liquid or colorless gas, or the like. The charged particles 221 are disposed within (e.g., suspended) the dielectric fluid 219. The charged particles 221 may be colored, black, white, reflectively colored, or other such colors or combinations of the like. The particles 221 may be formed from materials such as polyethylene, polystyrene, or other materials of the like.

The voltage driving device 217 is operably coupled to the drive electrode and the common electrode to apply a voltage thereto and induce an electric field therebetween, during operation of the pixel 201. The common electrode 209, illustratively, may operate as a common electrode of the pixel 201, and of several pixels generally, such as the several pixels 101 depicted in FIG. 1.

In accordance with the present system, upon application of a voltage by the voltage driving device 217, the electric field lines induced between the drive electrode 211 and the common electrode 209 may be redistribution forming generally, radial-shaped electric field lines distributed towards the pixel's 201 interior. In other words, the inner circular formation 215 formed by the facilitating structure 213 facilitates the electric field lines to be distributed more uniformly radial within the interior of the pixel 201. Re-distribution of the electric field lines radially generally increases the strength of the electric field lines induced through the center of the pixel 201, and thus, provides a more uniform distribution of the particles over the viewing aperture of the pixel 201 generally, and the drive electrode 211.

Via the facilitating structure 213, the pixel 201 may maintain a triangular, square, hexagonal, or other shaped structure having consideration to display panel construction characteristics, such as pixel coverage area within the display panel, while improving the uniformity of particle distribution regardless of the exterior pixel shape.

FIG. 3 illustrates field line redistribution of a pixel 301 including a facilitating structure 303 in accordance with an embodiment of the present system. Upon application of a voltage, electric field lines 309 induced between a drive electrode 315 and a common electrode (not shown to simplify the figure, that illustratively may be structurally similar to the common electrode 209 depicted in FIG. 2), are redistributed substantially radially symmetric towards the center of the pixel 301 due to an inner curved surface 311 of the facilitating structure 303. In this configuration, the facilitating structure 303 acts as a floating electrode due to an induced charge resulting from the electric field. As stated with regard to prior figures such as FIG. 2, the facilitating structure 303 may be positioned in proximity to the common electrode but is not in electrical contact with the common electrode. Accordingly, the charge resulting on the facilitating structure 303 is a result of the induced charge (e.g., capacitive coupling) and not a result of electrical conduction between the common electrode, the drive electrode, and the facilitating structure 303. Accordingly, the facilitating structure 303 operates as a floating electric field line redistributing electrode and does not serve as a particle collecting electrode.

FIG. 4 shows illustrative exterior shapes 403 that may be utilized by pixels and illustrative interior shapes of the corresponding facilitating structure 405, which illustratively may be formed as a continuous facilitating structure (e.g., continuous facilitating structure 407) or a discontinuous facilitating structure (e.g., discontinuous facilitating structure 409) according to the embodiments of the present system. Suitable exterior shapes include, but are not limited to, rectangular, triangular, hexagonal, and other closed geometric shapes having at least three sides, for example in two-dimensions, and curved shapes including circular and oval shaped. The exterior shape of the pixel may be selected based on design considerations, including but not limited to the pixel density of a display panel in which the pixel may reside as discussed above.

FIG. 5 shows an embodiment of the present pixel display system, consisting of a pixel 501 with a wall 503, a first facilitating structure 505 forming an inner curved formation 509 of similar formation as discussed with regard to FIGS. 1-4, and a second (floating) facilitating structure 507.

FIG. 5 represents a further incorporation of a second facilitating structure 507. The second facilitating structure is positioned beneath the drive electrode 513. The drive electrode 513 is shown having a further feature, illustratively shown as a generally circular window 515 formed (e.g., etched) into the drive electrode 513. In other embodiments, the particular shape of the window 515 may vary, such as rectangular, triangular, hexagonal, and other closed geometric shapes, for example in two-dimensions, having at least three sides, and curved shapes including circular and oval shaped, and the like as desired. The second facilitating structure 507 may be made of a material such as those suitable for conducting electricity including metallic and polymeric conductor films. The second facilitating structure 507 may be transparent, semi-transparent, or colored. The second facilitating structure 507 may act as a capacitive coupled electrode, and either protrudes up to or through the surface of the drive electrode 513, or not as desired. The second facilitating structure 507 functions similar in operation as the operation of the first facilitating structure 505 in that the electric field lines are redistributed due to capacitive coupling.

Further manipulation of the electric field lines to bring about uniform particle distribution in accordance with the present system is illustrated in the following FIGS. 6-11.

FIG. 6 shows manipulation of the electric field lines of a pixel 601 through the use of a planarizing and isolating film layer 613.

The pixel 601 comprises a top substrate 603 and a base carrier 605 with a predetermined gap set forth by the pixel wall 607. A displaying electrode 609 is positioned above the base carrier 605. The displaying electrode 609 may be colored, colorless, white, black, reflective, etc. A common (e.g., surrounding) electrode 611 may be embedded partially or fully within the pixel wall 607. Optionally, the common electrode could be formed as a thin conductive structured film situated on the surface of the base carrier 605 The gap created by the pixel wall 607 contains a dielectric fluid 615 in which charged particles 617 are dispersed therein. The dielectric fluid 615 is a colorless, transparent liquid made of, for example, silicone oil, toluene, xylene, high purity petroleum and other materials of the like as may be suitably utilized or a gas. The charged particles 617 may be colored, black, white, reflective, etc. as desired. The particles 617 may be made of materials such as polyethylene, polystyrene, and other materials of the like as may be suitably utilized.

The planarizing and isolating film layer 613 is illustratively shown deposited on top of the displaying electrode 609. As shown in FIG. 6, the film 613 may be formed (e.g., deposited) to result in preferential collecting areas, the forms may include but are not limited to, a slope, a pyramid, a cavern, a cut-out, and other shapes of the like as desired. Material that may be suitably utilized as the film layer 613 includes, but is not limited to, amorphous fluoresin, highly transparent polyimide, PET, silicon nitride (SiNₓ) silicon dioxide (SiOₓ), aluminum oxide (Al₂Oₓ), tantalum oxide and other similar material, such as other dielectric materials. The film 613 may be transparent, semi-transparent, or colored. The film 613 may also be formed as a color filter (CF) or an anti-sticking layer.

In accordance with this embodiment, the film 613 operates to stimulate the preferential collection of charged particles at a plurality of positions, wherein larger electric fields and field line densities selectively reside for a period of time. By selectively stimulating the pixel, the plurality of positions may be covered (e.g., filled) by the particles 617 in distinct steps, thereby producing improved grayscale or color distribution depending on the character of the particles 617 and the distinct steps.

FIG. 7 illustrates a method of operation of the pixel 701 comprising a film layer 703 in accordance with an embodiment of the present system.

Upon application of a voltage from the voltage driving device 705, the local electrical field strength is modified by means of the sloped film layer 703. Initially (e.g., after the pixel has been reset), the densest concentration of electric field lines and the larger electric field is present at the position where the modifying film 703 is the thinnest. The charged particles 707 have a preference to initially collect at this position. Next, as the particles 707 deposited within this initial position have a charge, the local field lines become shielded locally, and the position adjacent to the covered area becomes favored. Thus, by increasing and/or sustaining the applied electric field, the viewable portion of the pixel 701 becomes more and more covered by particles 707 in somewhat distinct steps. Further, by reversing the polarity, the viewable portion of the pixel 701 clears in reverse order, with the area having the thinnest film layer 703 clearing first thereby, providing further relative distinctive steps.

FIG. 8 shows examples of two embodiments of the present system. The first embodiment 801 shows a film layer 803 having a substantially pyramid shape. During operation, the particles first collect on either side of the pyramid. As those positions become shielded locally, the particles continue to fill up the adjacent positions as indicated by subsequent renditions of embodiment 801 shown in FIG. 8. The second embodiment 805 illustratively shows a film layer 807 having a substantially cavernous shape (e.g., an inverted pyramid). During operation, the particles first preferentially collect at the low point of the cavern. Again, as initial positions become shielded locally, the particles proceed to fill up adjacent positions.

As shown in FIGS. 7 and 8, the use of such a field modifying layer (e.g., film) allows for a substantially uniform, step-wise particle distribution. Illustratively, for dark colored particles, the present embodiment provides for an increase and improvement in color/grayscale gradation.

The present device may also contain two or more structured and isolating layers (e.g., films) present at the displaying (e.g., drive) electrode, containing features of the same size, diameter, and shape, or not, in a course or fine pattern, introducing a further configuration having sub-partitions at the pixel level (e.g., sub-pixels). Through sub-partitions, a multitude of slightly different preferential collecting areas, for example through surface area difference, film thickness, etc., will initiate a sequential like collection and release, at or from these areas, while in the case of a sub-partitioning across the pixel's surface area, an even better uniform coverage is achieved. These layers may be present on top of the displaying electrode as shown thereby creating an uneven surface, however, the local electric field modifications may be introduced by means of a planarizing and isolating film deposited on top of the displaying electrode, and covered by, for example, a planarizing film 621, such as an anti-sticking layer of a thickness to produce a surface area at the fluid interface that is substantially flat. In an alternate or additional embodiment, the topography at the displaying electrode may be introduced by structuring of the films underneath the displaying electrode, such as by used in current manufacturing methods at the TFT and storage capacitor level, as an alternative to depositing additional films on top of the displaying electrode.

FIGS. 9A, 9B illustrates an embodiment of the present device exhibiting sub-partitions within the pixel. In the pixel 901, a first film layer 903 is positioned above the displaying electrode 905 with a cutout 907 of the film layer made adjacent to the center of the displaying electrode 905. A second film layer 909 is positioned above the first film layer 903, however the second film layer is etched, deposited, etc., so that it is positioned only over the first film layer 903 illustratively shown on the right side of the pixel 901. Upon application of a voltage to the pixel, the charged particles 911 will have a preference to collect at the position where the densest concentration of electric field lines and larger electric field is present, which in this case is the area where the displaying electrode 905 is not covered by the film layers 903 and 909. As the local field lines at that location become shielded, the position that has the next densest concentration of electric field lines is filled. In this illustrative embodiment, the next filled area is the area covered only by the first film layer 903. As before, as this area becomes shielded the next area having the next densest concentration of electric field lines and next largest electric field is filled, which in this case is the area covered by both the first film layer 903 and the second film layer 909. With increasing the applied electric field, the pixel 901 thus becomes, for example, darker and darker. Consequently, on reversing the polarity, the pixel will clear in reverse order, with the area having no film layer clearing first.

The method of step-wise distributing charged particles in an electrophoretic display device using shaped film layers may be applied to colored display devices, as well as black and white (e.g., grayscale) display devices. In colored display devices, color filters may be employed using one or more filters. The filters may be RGB filters, CMY filters, or a combination of the two. The filters may be used to create sub-partitions within the pixel, and may be used in conjunction with one or more film layers. Two or more structured and isolating color filter layers may be present at the displaying electrode, having different thickness or dielectric constant, thereby modifying the local electric field at the viewing side of the displaying electrode. These layers may be present on top of the displaying electrode as shown thereby creating an uneven surface. In an alternate embodiment, the local electric field modifications may be introduced by means of a planarizing and isolating film deposited on top of the displaying electrode, and covered by color filter films or a planarizing film, such as the planarizing film 621 shown in FIG. 6, such as an anti-sticking layer of a thickness to produce a surface area at the fluid interface that is substantially flat. Note that the topography at the displaying electrode may be introduced by structuring of the films underneath the displaying electrode, such as by used in current manufacturing methods at the TFT and storage capacitor level, as an alternative to depositing additional films on top of the displaying electrode and/or color filter.

FIGS. 10A, 10B show an illustrative embodiment of the present system applied to colored display devices utilizing an RGB filter. The pixel 1001 includes a drive electrode 1003 upon which is positioned a color filter having sections 1013, 1015, 1017. In FIG. 10, the color filter is an RGB filter, wherein the left section 1013 is a red (R) color, the center section 1015 is a green (G) color, and the right section 1017 is a blue (B) color. A first film layer 1007 is positioned above the color filter, with a cutout 1009 above the center 1015 of the filter 1005. A second film layer 1011 is positioned (e.g., etched, deposited, etc.) atop the first film layer 1007, however the second film layer 1011 is formed (e.g., cut) such that it only covers the right section 1017 of the filter 1005.

As shown in FIGS. 10A, 10B upon applying a voltage to the pixel, the center cutout 1009 acts as a preferential collecting area. From an initial state, wherein the RGB layers are all uncovered, by applying a voltage, the pixel 1001 color appearance changes from white to magenta, representing the combination of the left section 1013 (red) and the right section 1017 (blue) of the filter 1005. On sustaining or increasing the voltage, the next favored area is covered, in this case the area above the first film layer 1007 on the left section 1013 of the filter 1005 and the pixel 1001 color appearance changes to blue, representing only the left section 1017 (blue) of the filter. At this stage, if the voltage is sustained or increased further, the third favored area will be covered, which is the area above the second film layer 1011, and the pixel 1001 will now change to black. If the polarity of the driving voltage is now reversed, the particles will be removed from the most preferential area first, in this case from the center cutout 1009. The pixel 1001 color appearance will change to cyan, representing the combination of the left section 1017 (blue) and the center section 1015 (green) of the filter 1005.

The pixel 1001 in FIGS. 10A, 10B may also start in a black state in which all the areas are covered by particles. Upon inverting the polarity of the voltage, the center cutout 1009 is cleared first, changing the appearance of the pixel 1001 to green. On sustaining or increasing the inversed voltage, the next preferential area is cleared which is the area above the first film layer 1001 above the left section 1013 of the filter 1005 and the pixel 1001 appearance change to yellows, representing the combination between the center section 1015 (green) and the left section 1013 (red) of the filter 1005. At this stage, if the inversed voltage is sustained or increased, all areas will be cleared, and the appearance of the pixel 1001 will change to white. If the inversed voltage is changed such that it becomes a positive voltage, the next preferential area will become filled first, in this case the center cutout 1009, and the pixel 1001 color will change to red, representing the uncovered left section 1013 (red) of the filter 1005.

The embodiment as set forth in FIGS. 10A, 10B may also be utilized with a system containing a CMY filter. FIG. 11 shows such a system containing a CMY filter. Starting at an initial state wherein the CMY filters are all uncovered, upon application of a voltage, the apparent color of the pixel 1001 changes from white to green. Sustaining or increasing the voltage further changes the apparent color of the pixel to yellow. At this stage, by increasing the voltage, the pixel now turns to black. By inversing the voltage, the filter areas may now be selectively uncovered similar as the previous RGB pixel discussed above.

In an alternative embodiment, in a colored display device, uniformly distributing charged particles may occur by modification to the topography of the drive electrode during the processing of the display device. The topographically modified drive electrode may be positioned underneath the color filter in the pixel. During processing, film layers of different thickness may be used for the introduction of topography before defining the drive electrode. The introduction of topography to the drive electrode at the TFT and storage capacitor level avoids additional processing. The drive electrode may still be planarized by a film layer or color filter.

As the present device manipulates the electric field line distribution to create more uniformity in the distribution of charged particles, pixel-to-pixel cross talk is decreased in the display device. The present device is suitable for use in display devices that employ enclosing a common (e.g., surrounding) electrode, as well as devices that do not employ such an enclosing common electrode.

Having described embodiments of the present system with reference to the accompanying drawings, it is to be understood that the present system is not limited to the precise embodiments, and that various changes and modifications may be effected therein by one having ordinary skill in the art without departing from the scope or spirit as defined in the appended claims. For example, while the modifying structures are generally discussed as being continuous structures, these structures may be readily modified in the form of partitions, sub-partitions, and/or sub-pixels without deviating from the present system. These modified structures may, in particular, be used to improve the color mixing within the pixel. Further, while the particles are illustratively discussed as being colored or reflective, as a person of ordinary skill in the art would readily appreciate, any combination of colored, reflective, differently colored, white and/or black particles, may also be suitably utilized wherein the different general types of particles (e.g., different colors) are selected having different charge characteristics, for example, such that the different general types of particles may be selectively mobilized.

Further, in the above description of embodiments of the present system, reference is made to the accompanying drawings which form a part hereof, and in which are shown by way of illustration specific embodiments in which the system may be practiced. These embodiments are described in sufficient detail to enable those of ordinary skill in the art to practice the presently disclosed system and it is to be understood that other embodiments may be utilized and that structural and logical changes may be made without departing from the spirit and scope of the present system. For example, as would be readily apparent to a person of ordinary skill in the art, the facilitating structures discussed herein clearly may be utilized in combination with the step-wise particle distribution layers as for example are discussed herein, without deviating from the spirit or scope of the present system. These combinations and other apparent combinations are clearly within the scope and intent of the present system. The description is therefore not to be taken in a limiting sense, and the scope of the present system is defined only by the appended claims.

In interpreting the appended claims, it should be understood that:

a) the word “comprising” does not exclude the presence of other elements or acts than those listed in the given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be compromised of hardware portions (e.g., including discrete and integrated electronic circuitry), software portions (e.g., computer programming), and any combination thereof;

f) hardware portions may be comprised of one or both of analog an digital portions;

g) any of the disclosed devices or portions thereof may be combined together or separated into further portions unless specifically stated otherwise; and

h) no specific sequence of acts or steps is intended to be required unless specifically indicated.

What is claimed is:

1. A pixel comprising:
an upper substrate and a base carrier (205, 605) disposed opposite each other;
a dielectric fluid with dispersed electrophoretic particles, the fluid being present between the upper substrate and the base carrier;
a surrounding electrode disposed around all or part of the dielectric fluid; and
a facilitating structure positioned in the pixel,
wherein the facilitating structure is configured to modify the electric field associated with the surrounding electrode.

2. The pixel of claim 1, wherein the facilitating structure is conducting and is configured to be electrically floating relative to the surrounding electrode.

3. The pixel of claim 1, wherein the facilitating structure is positioned along an inner surface of the surrounding electrode, and configured to have a curved inner surface.

4. The pixel of claim 1 further comprising a wall disposed on at least one of the upper substrate or the base carrier between the pixel and an adjacent pixel, the wall being configured to prevent migration of the electrophoretic particles between the pixel and the adjacent pixel.

5. The pixel of claim 4, wherein the surrounding electrode is disposed in proximity to the wall and extends substantially parallel to an interior surface of the wall.

6. A pixel, comprising:
an upper substrate and a base carrier disposed opposite each other;
a dielectric fluid with dispersed electrophoretic particles filled in a gap between the upper substrate and the base carrier;
a wall disposed on at least one of the upper substrate and the base carrier between adjacent pixels, configured to prevent migration of the electrophoretic particles between the adjacent pixels;
a surrounding electrode disposed in proximity to the wall and extending substantially parallel to an interior surface of the wall; and
a facilitating structure positioned along an inner surface of the surrounding electrode, and configured to have a curved inner surface, wherein the facilitating structure is configured to be electrically floating relative to the surrounding electrode.

7. The pixel of claim 6, wherein the facilitating structure is discontinuous along the inner surface of the surrounding electrode.

8. The pixel of claim 6, wherein the facilitating structure is continuous along the inner surface of the surrounding electrode.

9. The pixel of claim 6, wherein an exterior surface of the facilitating structure is substantially parallel to the inner surface of the surrounding electrode.

10. The pixel of claim 6, wherein an exterior surface of the wall is configured as a closed geometric shape having at least three sides.

11. The pixel of claim 6, comprising a drive electrode, disposed in proximity to the base carrier and extending substantially parallel to an interior surface of the base carrier.

12. The pixel of claim 11, wherein the facilitating structure is centered substantially over the drive electrode.

13. The pixel of claim 6, wherein the facilitating structure is configured from one of a transparent, semi-transparent or colored material.

14. The pixel of claim 6, wherein the facilitating structure is a first facilitating structure further comprising:
an opening configured in a portion of the drive electrode;
and a second facilitating structure positioned below the drive electrode.

15. The pixel of claim 14 wherein the opening is in a center portion of the drive electrode.

16. The pixel of claim 11, comprising a planarizing layer positioned above the drive electrode, wherein the planarizing layer is configured to exclude the dielectric fluid from between the planarizing layer and the drive electrode, and is configured to produce an increasing gap between the drive electrode and the dielectric fluid.

17. The pixel of claim 16, wherein the planarizing layer is configured to form one of a slope, a pyramid, a cavern, or a cutout surface facing the dielectric fluid.

18. The pixel of claim 16, wherein the drive electrode and the base carrier are configured such that the planarizing layer produces a surface area in contact with the dielectric fluid that is substantially flat.

19. The pixel of claim 16, wherein the planarizing layer is a first planarizing layer, the pixel comprising a second planarizing layer deposited onto the first planarizing layer and configured to produce a surface area in contact with the dielectric fluid that is substantially flat.

20. The pixel of claim 16, wherein the second planarizing layer is configured as an anti-sticking layer.

21. The pixel of claim 16, wherein the planarizing layer is a first planarizing layer, the pixel comprising a second planarizing layer deposited onto the base carrier in between the drive electrode, wherein the second planarizing layer is configured to produce a surface area of the first planarizing layer in contact with the dielectric fluid that is substantially flat.

22. The pixel of claim 16, wherein the planarizing layer is configured from a transparent material, the pixel comprising a colored filter.

23. The pixel of claim 22, wherein the colored filter is positioned below the planarizing layer.

24. The pixel of claim 22, wherein the colored filter is one of a plurality of colored filters configured to be colored in one of an RGB color system, a CMY color system, or a combination of RGB and CMY color system.

25. A method of forming a display, comprising the act of:
forming an upper substrate and a base carrier disposed opposite each other;
filling a dielectric fluid with dispersed electrophoretic particles into a gap between the upper substrate and the base carrier;
forming a wall disposed on at least one of the upper substrate and the base carrier between adjacent pixels, to prevent migration of the electrophoretic particles between the adjacent pixels;
positioning a surrounding electrode in proximity to the wall and extending substantially parallel to an interior surface of the wall; and
positioning a facilitating structure along an inner surface of the surrounding electrode, to provide a curved inner surface, that is electrically floating relative to the surrounding electrode.

26. The method of claim 25, comprising the acts of:
disposing a drive electrode in proximity to the base carrier and extending substantially parallel to an interior surface of the base carrier;
positioning a planarizing layer above the drive electrode, to exclude the dielectric fluid from between the planarizing layer and the drive electrode, and to produce an increasing gap between the drive electrode and the dielectric fluid.

27. The method of claim 26 wherein the pixel comprises a color filter.

28. The method of claim 26, comprising the act of forming the planarizing layer as one of a slope, a pyramid, a cavern, and a cutout surface facing the dielectric fluid.
